(19) United States
(12) Patent Application Publication
(10) Pub. No.: US 2021/0150648 A1
(43) Pub. Date: May 20, 2021

(54) SEARCH METHOD

(71) Applicant: Patrick A. NEELY, Maple Shade, NJ (US)

(72) Inventor: Patrick A. NEELY, Maple Shade, NJ (US)

(21) Appl. No.: 17/043,780

(22) PCT Filed: Apr. 1, 2019
(86) PCT No.: PCT/US2019/025230

§ 371 Date: Sep. 30, 2020

Related U.S. Application Data
(60) Provisional application No. 62/650,755, filed on Mar. 30, 2018.

(51) Int. Cl. G06Q 50/16; G06F 16/29; G06Q 40/02; G06F 16/9535; G06F 16/9537

(52) U.S. Cl. CPC G06Q 50/16; G06F 16/29; G06F 16/9537; G06F 16/9535; G06Q 40/025

(57) ABSTRACT

A method for locating real estate for purchase identifies properties in terms of the maximum monthly payment a user can afford.

### CROSS-REFERENCE TO RELATED APPLICATION

This application claims the priority of U.S. Provisional Application 62/650,755 filed Mar. 30, 2018 which is incorporated herein in its entirety by reference.

### BACKGROUND OF THE INVENTION

### 1. Field of the Invention

This invention relates to on-line search methods for real estate.

### 2. Brief Description of the Prior Art

Searching for real estate to purchase has become simultaneously easier in some senses and paradoxically more difficult in other senses with the advent of computerized search methods and the Internet. A user now has a variety of search sites such as zillow.com, that can quickly show available properties within a specified geographic location along with a host of related information. The plethora of available information has also made it more difficult to make a decision whether to make an offer on available properties, as many factors other than location and price may be important to the potential real estate buyer.

Real estate search methods are well known in the art. For example, U.S. Pat. No. 5,032,989 A discloses a method for locating available real estate properties for sale, lease or rental using a database of available properties at a central location and remote stations which use a graphic interface to select desired regions on a map of the areas in interest. U.S. Pat. No. 6,519,618 B1 discloses a method of searching a plurality of MLS (multiple listing service) databases. U.S. Pat. No. 6,636,803 B1 discloses a search and retrieval system which includes a data terminal which displays icons representing properties in a given real-estate market. U.S. Pat. No. 7,430,555 B2 discloses a system and method for transacting retrieval of real estate property listings using a remote client interfaced over an information network. U.S. Pat. No. 8,024,349 B1 discloses string-based systems and methods for searching for real estate properties. U.S. Pat. No. 9,104,782 B2 discloses a system and method for searching real estate listings using imagery. U.S. Pat. No. 9,141,650 B2 provides MLS systems and methods for advanced features for online mapping, searching, and planning driving tours. U.S. Pat. No. 9,224,177 B 2 discloses systems and methods for searching for and translating real estate descriptions from diverse sources utilizing an operator-based product definition. U.S. Patent Publication 2015/0235330 A1 discloses a real estate searching system with activation code enabled.

Despite the advancements made in computer-enabled real estate searching, there is a continuing need to simplify the process and to take into account the priorities of the would-be real estate purchaser.

### SUMMARY OF THE INVENTION

The present invention provides a method for searching for real estate based on mortgage payment. By limiting the home search results by a defined characteristic of maximum monthly mortgage payment, a user is relieved of the often difficult task of assessing the search results fit with his or her maximum affordable total monthly mortgage payment. In one aspect, the present invention provides a method wherein a user narrows his or her search for a home by employing a maximum monthly mortgage payment. In another aspect of the method of the present invention, the maximum monthly mortgage payment is defined by the user's desired down payment, the user's credit score, and the loan type and terms desired by the user. In another aspect, the process of the present invention computes a renovation budget to define in view of a subject property's maximum monthly mortgage payment the monies available for renovation of the subject property. In another aspect, the present method identifies by condition, subdivision or neighborhood, price per square foot, and design, an expected days on the market in view of comparable sold property listings and identifies the predicted time the subject property is likely to remain available for sale on the market before it is expected to turn to a pending sale status.

The present invention thus provides a method for locating real estate for purchase. The method includes providing a maximum possible monthly real estate expenditure for a user and providing a database of real estate listings including location and asking price. Preferably, the method further includes providing mortgage information including mortgage provider, mortgage interest rate, mortgage term, mortgage type, and any associated fees, as well as defining a desired geographic location and identifying real estate being offered for sale within the desired geographical location. Preferably, the method further includes computing the monthly mortgage cost for each real estate property being offered within the desired geographical area, and comparing the monthly mortgage cost for each real estate offering within the desired geographical area with the maximum possible monthly real estate expenditure for the user. Preferably, the method further includes displaying to the user each real estate offering within the desired geographical area which has a monthly mortgage cost less than or equal to the user's maximum possible monthly real estate expenditure.

In another aspect the method further includes computing, for each mortgage provider, the cost for each real estate offering within the desired geographical area; comparing the monthly mortgage cost for each mortgage provider for each real estate offering within the desired geographical area with the maximum possible monthly real estate expenditure for the user; and displaying to the user each real estate offering within the desired geographical area which has a monthly mortgage cost less than or equal to the user's maximum possible monthly real estate expenditure for each mortgage provider.

In another aspect the method further includes providing real estate tax information for real properties, the real estate tax information including real property location and associated real estate tax; computing the real estate tax for each real estate property being offered for sale within the desired geographical location; computing a monthly allocation of the real estate tax for each real estate property being offered within the desired geographical area; computing the monthly cost of ownership for each real estate property being offered within the desired geographical location, the monthly cost of ownership including the monthly allocation of the real estate tax and the monthly mortgage cost; and, preferably, displaying to the user each real estate offering within the desired geographical area which has a monthly cost of ownership less than or equal to the user's maximum possible monthly real estate expenditure.

In yet another aspect, the present method further includes providing utility cost information for real properties, the real estate tax information including real property location and associated utility cost; computing the utility cost for each real estate property being offered for sale within the desired geographical location; computing a monthly utility cost for each real estate property being offered within the desired geographical area; and computing a monthly total cost of ownership for each real estate property being offered within the desired geographical location, the monthly cost of ownership including the monthly allocation of the real estate tax, the monthly mortgage cost; and the monthly utility cost, and optionally displaying to the user each real estate offering within the desired geographical area which has a monthly total cost of ownership less than or equal to the user's maximum possible monthly real estate expenditure.

In another aspect, the present method includes providing a maximum possible monthly real estate expenditure for a user; providing a database of real estate listings including location and asking price, providing mortgage information including mortgage provider, mortgage interest rate, mortgage term, mortgage type, and any associated fees, providing real estate tax information for real properties, the real estate tax information including real property location and associated real estate tax; defining a desired geographic location; identifying real estate being offered for sale within the desired geographical location, computing the monthly mortgage cost for each real estate property being offered within the desired geographical area; computing the real estate tax for each real estate property being offered for sale within the desired geographical location; computing a monthly allocation of the real estate tax for each real estate property being offered within the desired geographical area; computing a monthly cost of ownership for each real estate property being offered within the desired geographical location, the monthly cost of ownership including the monthly allocation of the real estate tax and the monthly mortgage cost; and comparing the monthly cost of ownership for each real estate offering within the desired geographical area with the maximum possible monthly real estate expenditure for the user; and optionally displaying to the user each real estate offering within the desired geographical area which has a monthly cost of ownership less than or equal to the user's maximum possible monthly real estate expenditure.

In this aspect, the method further optionally includes computing, for each mortgage provider, the cost for each real estate offering within the desired geographical area; comparing the monthly mortgage cost for each mortgage provider for each real estate offering within the desired geographical area with the maximum possible monthly real estate expenditure for the user; and optionally displaying to the user each real estate offering within the desired geographical area which has a monthly mortgage cost less than or equal to the user's maximum possible monthly real estate expenditure for each mortgage provider.

In this aspect, the method further optionally includes providing utility cost information for real properties, the real estate tax information including real property location and associated utility cost; computing the utility cost for each real estate property being offered for sale within the desired geographical location; computing a monthly utility cost for each real estate property being offered within the desired geographical area; computing a monthly total cost of ownership for each real estate property being offered within the desired geographical location, the monthly cost of ownership including the monthly allocation of the real estate tax, the monthly mortgage cost; and the monthly utility cost; and optionally displaying to the user each real estate offering within the desired geographical area which has a monthly total cost of ownership less than or equal to the user's maximum possible monthly real estate expenditure.

In yet another aspect the method of the present invention preferably further includes identifying comparable real estate properties to each real estate offering within the desired geographical area which has a monthly mortgage cost less than or equal to the user's maximum possible monthly real estate expenditure; computing a prediction of the expected days remaining on market for at least one of the each real estate offering; and optionally presenting to the user the prediction.

In this aspect, the comparable real estate properties are preferably determined by weighing at least one factor selected from the group consisting of location, price per square foot, condition, and home design.

In another presently preferred embodiment, the method of the present invention further includes computing the amount of renovation financing available for at least one of each real estate offering within the desired geographical area which has a monthly mortgage cost less than or equal to the user's maximum possible monthly real estate expenditure; and optionally displaying the computed amount of renovation financing available to the user.

### BRIEF DESCRIPTION OF THE FIGURE

FIG. 1 provides an implementation of a presently preferred embodiment of the method of the present invention in Python.

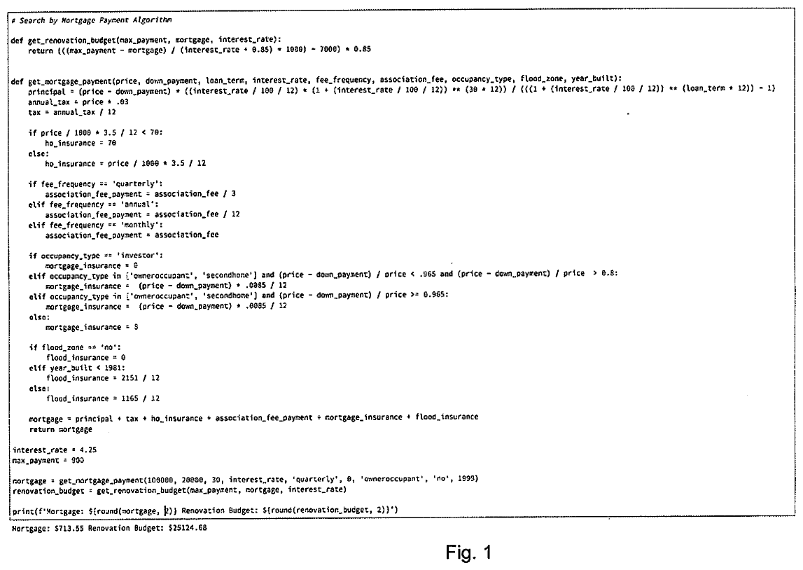

### DETAILED DESCRIPTION OF THE PREFERRED EMBODIMENTS

The Home Search By Monthly Payment is a revolutionary and new concept that will allow it's users, be it either real estate agents, who can use the service to provide personally tailored offers of homes for sale to their customers, or customers, who can themselves find the house of their dreams they can afford and then directly contact the agents for guidance.

The present method preferably employs high-fidelity data to calculate some of the many components, of which the monthly mortgage payment is composed, and other values that are crucial to finding the right home. The present method employs a database, which stores the financing conditions, rates and data required to share search results between users and agents.

The method of the present invention can be implemented, for example, in the PHP language. For example, a primary file can be a functions file, which contains all the algorithms for figuring many variables, such as:

Mortgage financing type for the current listing—FNMA, FHA, USDA, VA—according to the input specifications of the property, its occupation and the down payment percent.

The specific loan limit for the property parameters, county, and loan financing type.

The loan amount needed to cover the expenses included with the purchase of the property.

The interest rate for the loan, according to the most actual matrices for given property parameters and loan financing type.

The principal and interest amount for the loan amount, interest rate and term.

The mortgage insurance payment for the loan amount and financing type.

The normalized homeowner association and condominium fees to a monthly rate.

The monthly renovation budget that still fits in the maximum all-in monthly payment.

All of the formulas are high-fidelity and most accurately depict the real world applications.

The present invention employs real data, not just estimated numbers, and provides the ability to fully customize the search and financial criteria, while still targeting a full-on user-friendly operation and guiding the user through the intricate process safely to the destination.

The present invention provides an improvement in the functional focus of a real estate search engine which provides consumers a best effort disclosure of true cost upfront as they are shopping for real estate. The clarity that the result set provides introduces a significant savings of time and emotional energy as real estate buyers seek out their next purchase. The present search method provides the consumer disclosure of true costs to better manage user expectations, saving the real estate purchasing public time and aggravation.

According to a recent poll, 52% of people say the most difficult step is finding the right house, and that the average time someone spends searching for housing online is fourteen hours. Eight minutes per a thirty minute search is the time spent calculating mortgage payments. Four hours time spent reiterating the search to define the total monthly mortgage payment by current state of art. Thus, the present search method can save up to four hours for each buyer transaction. The number of purchase residential mortgage loans secured by U.S. residential properties (1 to 4 units) in 2017 was 2,053,400, and the average new mortgage balance was $244,003 (https://www.magnifymoney.com/blog/mortgage/u-s-mortgage-market-statistics-2017/). If this information is input into the method of the present invention (assuming a $20,000 deposit) a monthly mortgage payment of $1,974.83 is calculated. To qualify a borrower(s) must earn $1,974.83. (0.31 “GuidelineforMaxHousingPayment-to-Income”)=$6,367.74 per month (annually $76,412; and hourly=annual/52 weeks/FullTime40 hours=$36.74 per hour). Thus, the total economic impact of the method of the present invention can be estimated as follows:

Total U.S. household savings=4 hours×2,053,400 financed purchases in 2017×earnings of $35.74 per hour ($293,554,064). Thus, the total economic impact is estimated as $1,232,040,000.

According to NAR Home Buyer and Seller Generational Trends Report 2017 Profile of Home Buyers and Sellers, all generations, except Generation X, spent eight weeks searching for a home. 56% of Millennials found their home on the Internet versus the Silent Generation, who found it more frequently through a real estate agent. In 2001, all buyers on the average spent seven weeks looking for a home. In 2005, eight weeks were spent. In 2009 and 2013, twelve weeks were spent. In 2016, ten weeks were spent. The number of homes viewed was ten on average. The most difficult step of the home buying process was finding the right property among all generations (52 percent), while understanding the process and the involved paperwork were more difficult for Millennials than any other generation. 27 percent of Older Boomers noted there were no difficult steps compared with only 9 percent of Millennials. Internet searching is important in the home buying process, although use of the internet to search for a home decreases with age. Only 5 percent of Realtor® firms do not have a website while 93 percent report having a website. The percentage of firms with websites increases with office size. 99 percent of firms with five or more offices have websites. The most common feature on firms' websites were property listings at 95 percent. Commercial firms typically showed property listings (88 percent), agent and staff photos (77 percent), and customer reviews and testimonials (36 percent). Residential firms typically showed property listings (97 percent), agent and staff photos (80 percent), and mortgage/financial calculators (62 percent). Real estate firms provide their agents and brokers with specific software. Overall the most encouraged software was multiple listing. At firms with four or more offices, the two most used were multiple listing and electronic contracts/forms, both at 92 percent. When asked about the amount of technology that their broker currently offers, 45 percent of REALTORS® said that they would like to see the amount of technology offered expanded. Some of the top offerings that REALTORS® would like to see included are: More tech support/training; a more professional website; cutting edge technology; a better CRM database; keeping agents up to date; more reliable faster Internet; and easier to use technology.

Another element of the method of the present invention is to align the buying public with a true sense of the sale cycle for the real estate asset of interest. Preferably, the method of the present invention intelligently summarizes the days on market of comparable sold assets, comparable by location, price per square foot, condition, and home design (one story, two story, cape, bi-level, raised ranch, flat, etc.) and presents the user with a prediction of the expected days remaining on the market for an active asset. This predicted days remaining active for sale before turning pending under contract reveals to the user an imperative contextual data point that empowers the user with the choice to prioritize and plan to achieve a desired outcome in view of a likely expectation that by the timeline presented the real estate asset may no longer be available for purchase.

Another advantage of the method of the present invention solves the problematic economic implications brought by the market characteristics of low real estate inventory relative to the growing demand. Uniquely, the present method provides a solution that adjusts the supply to demand curve to alleviate price pressures that lead to inflation. This outcome of supply demand shift is specifically achieved by the method to relate the available renovation financing dollars for each search result by mortgage payment in view of the subject property's total mortgage payment in its as-is condition relative to the buyer's maximum monthly budget. By disclosing the dollars available for renovation at the present mortgage payment relative to the buyer's maximum budget achieves to make distressed and dated unmarketable assets in neighborhoods a purchase option that may have otherwise been overlooked.

For example, In just three counties in New Jersey (Burlington, Camden and Gloucester) near Philadelphia, Pa., there were 30,000 vacant and distressed real estate assets in established neighborhoods amidst tremendous housing demand provided by new employment in the Philadelphia Metro area.

In economic terms, the present method immediately increases market liquidity for this distressed and dated real estate asset category, typically a foreclosure, and no longer owned by the original owner occupant, rather an asset/liability on the balance sheet of the commercial banks. The present method facilitates discovery for buyers early in the sale cycle which accelerates the rate of sales for these assets, turning them into improved homes in established neighborhoods, improving the surrounding home values, alleviating the liabilities on the bank's balance sheet for a net gain thereby improving the bank's credit rating and effecting to enabling additional credit access in consumers in the marketplace and bolstering local, national and international economic growth.

Home improvement activity is a job creator, saves the environment resources by salvaging components of the real estate structure and supports investment into technology relevant to present consumer preferences (energy efficient and non-toxic materials). Market demand for installation of these goods creates new jobs and provides households in the communities a sustainable increase in income and quality of life.

This method of the present invention achieves a value proposition that is so compelling that a user would seek out to search for a home by mortgage payment rather than the search engine technologies in the state of the art provided by Zillow and other technology vendors.

The method of the present invention can be implemented in various formats, such as by a suitably functionalized website linked to appropriate databases and database engine. Alternatively, the method can be implemented on a suitable spreadsheet such as in Microsoft Excel.

The following provides an example of the implementation of the method of the present invention.

| Type | Symbol | Variable | Value | Remark |
|---|---|---|---|---|
| INPUT | T | Town(s) | | |
| INPUT | SD | Subdivision | | |
| | | Neighborhood(s) | | |
| INPUTTOAPI | DT | Drive Time To/From | | |
| | | Destination | | |
| INPUT | B | | 3+ | |
| INPUT | BA | Baths | 2+ | |
| INPUT | PBA | Partial Baths | | |
| INPUT | D | Design (1, 1.3 = 5, 2, | 2 story | Learn more |
| | | 2.5, 3+, e.) Select all | | |
| | | that apply | | |
| CALL | AP | ASKING PRICE | 100,000.00 | Meet a Local Real |
| Results from | | | | Estate Expert |
| Bright MLS | | | | |
| CALL | AT | Annual Taxes | 3,000.00 | Consult a CPA |
| Results from | | | | |
| Bright MLS | | | | |
| CALL | AF | ASSOCIATIONFEE | | Learn More |
| Results from | | | | |
| Bright MLS | | | | |
| CALL | FF | Fee Frequency | quarterly | |
| Results from | | | | |
| Bright MLS | | | | |
| CALL Third | -FZ | Flood Zone | NO | Speak with a |
| Party API | | | | qualified |
| | | | | Insurance Agent |
| CALL | YB | Year Built | 1999 | |
| Results from | | | | |
| Bright MLS | | | | |
| INPUT | CTCK | CASH TO COLLECT | 20,000.00 | Learn More |
| | | KEYS | | |
| INPUT | LT | LOAN TERM IN | 30.00 | Consult a |
| | | YEARS | | Financial Advisor |
| INPUT | ECS | Estimated Credit | 720 | Improve your |
| | | Score | | Credit Score and |
| | | | | Save |
| INPUT | OT | Occupancy Type | owneroccupant | Learn More |
| | | (“owner occupant”, | | |
| | | “investor”, “second | | |
| | | homeowner | | |
| | | occupant | | |
| INPUT | MP | MAX PAYMENT | 900.00 | Get Pre-Approved |
| FILTER AT | | | | |
| OR BELOW | | | | |
| CALL | AP | ASKING PRICE | 100,000.00 | Meet a Local Real |
| Results from | | | | Estate Expert |
| Bright MLS | | | | |
| GENERATE | | Estimate Payment | 713.55 | Get Pre-Approved |
| RESULTS | | | | |
| DISPLAY | RE | Renovation Budget | 25,124.68 | Meet a |
| | | | | Renovation |
| | | | | Consultant |
| ALGORITHM | IR | 4.25 | | |
| 1 | | | | |
| ALGORITHM | P | 393.55 | | |
| 2 | | | | |
| ALGORITHM | Tax | 250.00 | | |
| 3 | | | | |
| ALGORITHM | HomeOwnersInsurance | 70.00 | | Consult an |
| 4 | | | | Insurance |
| | | | | Professional |
| ALGORITHM | Association Fee | 0 | | |
| 5 | | | | |
| ALGORITHM | Mortgage Insurance | 0 | | |
| 6 | | | | |
| ALGORITHM | Flood Insurance | 0 | | |
| 7 | | | | |

Shaded fields indicate user specifications such as home characteristics and cash to collect keys (i.e. downpayment, loan term (years), estimated credit score, occupancy type, and maximum monthly payment.

Wherein column 1 is A, column 2 is B, column 3 is C, column 4 is D, and so on.

Wherein row is 1, row 2 is 2, row 3 is 3, and soon.

The computational algorithms are:

ALGORITHM 1: =1F(AND(D9=“OWNEROCCUPANT”,D18>720,((D10−D16)/D10)<=0.8),4.25,IF(AND(D19=“OWNEROCCUPANT”, D8>=720,((D10−D16)/D10)>0.8),4.5,4.875))

ALGORITHM 2: (D10−D16)*((C25/100/12)*(1+(C25/100/12))A(D17*12))/(((1+(C25/100/12))A(D17*12))−1)

ALGORITHM 3: =D11/12

ALGORITHM 4: =IF((((D10/1000)*3.5)/12)<70,70,(((D10/1000)*3.5)/12))

ALGORITHM 5: =(IF(D13=“QUARTERLY”,(D12/3), IF(D3=“Annual,D2/12,IF(D13=“monthly”,D12,I))))

ALGORITHM 6: =1F(D19=“INVESTOR”,0,IF(AND(OR(D19=“OWNERCOCCUPANT”,D19=“SECONDHOME”),(((D10−016)/D10)<0.965),((D10−016)/D10)>0.8),(D10−D16)*0.0085/12,IF(AND(OR(D19=“OWNEROCCUPANT”,D19=“SECONDHOME”),((D10−D16)/D10)>0.965),((D10−D16)*0.0085/12),0)))

ALGORITHM 7: =IF(D14=“NO”,0,IF(D15<1981,2151/12,1165/12))

ESTIMATE PAYMENT=SUM(C26:C31)

RENOVATION BUDGET=((((D20D21)/(C25+0.85))*1000)−7000)*0.85

The following is a detailed example of an application of the method of the present invention:

### Step 1: Limit Data Set of Listings by Property Design

| | |
|---|---|
| Limit Property | PropertyAttachedYN |
| Geography (STATE, | NewConstructionYN |
| COUNTY, CITY, NEIGHBORHOOD/ | |
| SUBDIVISION, ZipCode) | |
| BedroomsTotal | YearBuilt |
| BathroomsFull | AccessToPoolYN |
| BathroomsHalf | PoolPrivateYN |
| MainLevelBedrooms | WaterfrontYN |
| MainLevelFullBaths | SeniorCommunityYN |
| MainLevelHalfBaths | LotSizeAcres |
| PropertyType | LotSizeArea |
| BasementYN | LotSizeDimensions |
| AboveGradeFinishedArea | HeatingFuel |
| CentralAirYN | HighSchool |
| LaundryType | ElementarySchool |
| PropertyType | Zoning |
| PropertySubType | ZoningDescription |
| Stories | Sewer |
| StructureDesignType | WaterSource |
| GarageYN | PricePerSquareFoot |
| GarageSpaces | AssociationName |
| ParkingTotal | AssociationName2 |
| AssignedParkingSpaces | AssociationYN |
| OpenParkingYN | AttachedGarageYN |
| ParkingTotal | AvailabilityDate |
| CondoYN | AssociationFeeIncludes |
| HoaYN | PropertyCondition |

Step 2: Goal is to Exclude all LA that are Greater than FHA, VA, USDA, FNMA Loan Limits by County, State and #of Units.

To do so define Loan Amount

To do so First Define the Loan Program

To do so request the following input from user:
Occupancy Type: Primary, Second, Investment
Credit: Excellent (720+), Average (680-719), Below Average (620-679)
Liquid Reserves (LR) for Home Purchase to include Down Payment & Closing Costs.
Veteran Status: VeteranYN, reserve, regular, first time, repeat.
Term (0-20 years, 20.1-30 years)

Calculate amount of downpayment available after average closing costs by state and county (Transfer Taxes, Tax, Homeowners Insurance, and Association Escrows, Tax Reimbursements, Upfront Association Condo Fee, Title Insurance, Appraisal (1 unit: $475, 2-4 units $650), Settlement Service Provider Fees, Home Inspection, and more) Adjust available funds by reimbursing % of the AP by Zip Code average Seller Assist as a % (limited by acceptable % amount by loan program).

Here use 3% of AP as Closing Costs (CC)

Now with “LR” subtract (3%*AP) this results in your Downpayment (DP)

Determine % DP represents of AP.

Reduce AP by DP to calculate base loan amount (BLA)

Apply Logic disclosed to Determine Loan Program (LP).
Use additional input from user: Occupancy, Veteran Status, Credit, % DP
Use Listing Data: Asking Price, County & State, #Units, USDA acceptable financing or not

| Occupancy: | | Units: | |
|---|---|---|---|
| OWNER OCCUPANT | VETERAN | 1-4 | VA |
| CREDIT: | NON VETERAN | 1-4 | |
| Excellent | IF DP/PP <5% USDA ELIG THEN USDA, IF ITS NOT USDA ELIG IF <3%,THEN | | |
| | EXCLUDE, IF NOT USDA ELIG AND IF(=>3%, <3.5%)USE FNMA, =>3.5% | | |
| | AND <5% USE FHA, =>3.5% AND <5% USE FHA, >=5% USE FNMA | | |
| Average | IF DP/PP <5% USDA ELIG THEN USDA, IF ITS NOT USDA ELIG IF <3%, THEN | | |
| | EXCLUDE, IF NOT USDA ELIG IF(=>3%, <3.5%)USE FNMA, =>3.5% | | |
| | AND <5% USE FHA, >=5% USE FNMA | | |
| Below Average | AT ANY DP/PP IF USDA ELIG THEN USDA, IF <3.5% NOT USDA THEN | | |
| | EXCLUDE, OTHERWISE IF NOT USDA AND =>3.5% USE FHA | | |
| INVESTOR | VETERAN | 1 | DP/PP >=0% VA |
| | NON VETERAN | 1 | DP/PP >=15% FNMA |
| | VETERAN, NON VETERAN | 2-4 | DP/PP >=25% FNMA |
| SECOND HOME | VETERAN, NON VETERAN | 1 | FNMA |
| | | 2-4 | EXCLUDE, NO FINANCING |

For LP, apply Upfront Funding Fees_Insurance to adjust BLA.

| | |
|---|---|
| FHA | =(AP − CC)*(101.75%) |
| FNMA | =AP − CC |
| USDA | =[AP − CC]*101% |
| VA | =[AP − CC]*{1 + |
| | VAFUNDINGFEEMATRIXRATE(ARE |
| | YOU REGMILT OR RESERVES, |
| | X: DP/AP, Y: FIRST, SUBSEQUENT)) |

VA Funding Fee Matrix as of Apr. 1, 2019

| | 0-5% | 5-9.99% | 10%+ |
|---|---|---|---|
| Regular Military | | | |
| First Time Use | 2.15% | 1.50% | 1.25% |
| Subsequent | 3.30% | 1.50% | 1.25% |
| Reserves National Guard | | | |
| First Time Use | 2.40% | 1.75% | 1.50% |
| Subsequent | 3.30% | 1.75% | 1.50% |

Find Loan Limit (LL) Matrix for Loan Program find LL by Property Detail (#of Units & County, State).

### Example

2019 FHA Loan Limits

| | One-Unit | Two-Unit | Three-Unit | Four-Unit |
|---|---|---|---|---|
| | Limit | Limit | Limit | Limit |
| HALE, AL | $331,200 | $424,000 | $512,500 | $636,900 |
| PICKENS, AL | $331,200 | $424,000 | $512,500 | $636,900 |
| TUSCALOOSA, AL | $331,200 | $424,000 | $512,500 | $636,900 |

The same follows for 2019 VA & FNMA, USDA matrix published amounts.

Exclude LA>LL.

On all listings that remain, calculate P+I.

To calculate P+I determine the IR.

Determine the Interest Rate (IR)

First Find Loan Program Interest Rate Matrix

Example FNMA:

| Occupancy | Primary | | | | | | |
|---|---|---|---|---|---|---|---|
| Units | 1 | 1 | | | | | |
| Term | 20 | 30 | 3 | 5 | 10 | 15 | 20 |
| | 720 | 850 | 4.750% | 4.625% | 4.500% | 4.375% | 4.250% |
| | 680 | 719 | 5.00% | 4.875% | 4.750% | 4.625% | 4.500% |
| | 620 | 679 | 5.25% | 5.125% | 5.000% | 4.875% | 4.750% |
| Occupancy | Second | | | | | | |
| Units | 1 | 1 | | | | | |
| Term | 20 | 30 | 3 | 5 | 10 | 15 | 20 |
| | 720 | 850 | 0.00% | 0.00% | 4.875% | 4.750% | 4.625% |
| | 680 | 719 | 0.00% | 0.00% | 5.125% | 5.000% | 4.875% |
| | 620 | 679 | 0.00% | 0.00% | 5.250% | 5.125% | 5.000% |
| Occupancy | Investment | | | | | | |
| Units | 1 | 1 | | | | | |
| Term | 20 | 30 | 3 | 5 | 10 | 15 | 20 |
| | 720 | 850 | 0.00% | 0.00% | 0.00% | 5.1250% | 5.000% |
| | 680 | 719 | 0.00% | 0.00% | 0.00% | 5.3750% | 5.250% |
| | 620 | 679 | 0.00% | 0.00% | 0.00% | 5.5000% | 5.500% |
| Occupancy | Primary | | | | | | |
| Units | 2 | 2 | | | | | |
| Term | 20 | 30 | 3 | 5 | 10 | 15 | 25 |
| | 720 | 850 | 0.00% | 0.00% | 0.00% | 4.625% | 4.500% |
| | 680 | 719 | 0.00% | 0.00% | 0.00% | 4.875% | 4.750% |
| | 620 | 679 | 0.00% | 0.00% | 0.00% | 5.125% | 5.000% |
| Occupancy | Primary | | | | | | |
| Units | 3 | 4 | | | | | |
| Term | 20 | 30 | 3 | 5 | 10 | 15 | 25 |
| | 720 | 850 | 0.00% | 0.00% | 0.00% | 0.00% | 4.750% |
| | 680 | 719 | 0.00% | 0.00% | 0.00% | 0.00% | 5.000% |
| | 620 | 679 | 0.00% | 0.00% | 0.00% | 0.00% | 5.250% |
| Occupancy | Investment | | | | | | |
| Units | 2 | 4 | | | | | |
| Term | 20 | 30 | 3 | 5 | 10 | 15 | 25 |
| | 720 | 850 | 0.00% | 0.00% | 0.00% | 0.00% | 5.125% |
| | 680 | 719 | 0.00% | 0.00% | 0.00% | 0.00% | 5.375% |
| | 620 | 679 | 0.00% | 0.00% | 0.00% | 0.00% | 5.625% |
| Occupancy | Primary | | | | | | |
| Units | 1 | 1 | | | | | |
| Term | 0 | 20 | 3 | 5 | 10 | 15 | 20 |
| | 720 | 850 | 4.375% | 4.250% | 4.125% | 4.000% | 3.875% |
| | 680 | 719 | 4.625% | 4.000% | 3.875% | 3.750% | 3.625% |
| | 620 | 679 | 4.875% | 3.750% | 3.625% | 3.500% | 3.375% |
| Occupancy | Second | | | | | | |
| Units | 1 | 1 | | | | | |
| Term | 0 | 20 | 3 | 5 | 10 | 15 | 20 |
| | 720 | 850 | 0.00% | 0.00% | 4.500% | 4.375% | 4.250% |
| | 680 | 719 | 0.00% | 0.00% | 4.750% | 4.625% | 4.500% |
| | 620 | 679 | 0.00% | 0.00% | 5.000% | 4.875% | 4.750% |
| Occupancy | Investment | | | | | | |
| Units | 1 | 1 | | | | | |
| Term | 0 | 20 | 3 | 5 | 10 | 15 | 20 |
| | 720 | 850 | 0.00% | 0.00% | 0.00% | 4.750% | 4.625% |
| | 680 | 719 | 0.00% | 0.00% | 0.00% | 5.000% | 4.875% |
| | 620 | 679 | 0.00% | 0.00% | 0.00% | 5.250% | 5.125% |
| Occupancy | Primary | | | | | | |
| Units | 2 | 2 | | | | | |
| Term | 0 | 20 | 3 | 5 | 10 | 15 | 20 |
| | 720 | 850 | 0.00% | 0.00% | 0.00% | 4.250% | 4.125% |
| | 680 | 719 | 0.00% | 0.00% | 0.00% | 4.500% | 4.375% |
| | 620 | 679 | 0.00% | 0.00% | 0.00% | 4.750% | 4.625% |
| Occupancy | Primary | | | | | | |
| Units | 3 | 4 | | | | | |
| Term | 0 | 20 | 3 | 5 | 10 | 15 | 25 |
| | 720 | 850 | 0.00% | 0.00% | 0.00% | 0.00% | 4.375% |
| | 680 | 719 | 0.00% | 0.00% | 0.00% | 0.00% | 4.625% |
| | 620 | 679 | 0.00% | 0.00% | 0.00% | 0.00% | 4.875% |
| Occupancy | Investment | | | | | | |
| Units | 2 | 4 | | | | | |
| Term | 0 | 20 | 3 | 5 | 10 | 15 | 25 |
| | 720 | 850 | 0.00% | 0.00% | 0.00% | 0.00% | 4.750% |
| | 680 | 719 | 0.00% | 0.00% | 0.00% | 0.00% | 5.000% |
| | 620 | 679 | 0.00% | 0.00% | 0.00% | 0.00% | 5.250% |

Same Follows to market rates and loan program guide lines for available financing.

Example of Renovation FNMA Financing Rates.

| Occupancy | Primary | | | | | | |
|---|---|---|---|---|---|---|---|
| Units | 1 | 1 | | | | | |
| Term | 20 | 30 | 3 | 5 | 10 | 15 | 20 |
| | 720 | 850 | 0.00% | 5.000% | 4.875% | 4.750% | 4.625% |
| | 680 | 719 | 0.00% | 5.25% | 5.125% | 5.000% | 4.875% |
| | 620 | 679 | 0.00% | 5.50% | 5.375% | 5.250% | 5.125% |
| Occupancy | Primary | | | | | | |
| Units | 2 | 2 | | | | | |
| Term | 20 | 30 | 3 | 5 | 10 | 15 | 20 |
| | 720 | 850 | 0.00% | 0.00% | 0.00% | 4.875% | 4.750% |
| | 680 | 719 | 0.00% | 0.00% | 0.00% | 5.125% | 5.000% |
| | 620 | 679 | 0.00% | 0.00% | 0.00% | 5.375% | 5.250% |
| Occupancy | Primary | | | | | | |
| Units | 3 | 4 | | | | | |
| Term | 20 | 30 | 3 | 5 | 10 | 15 | 25 |
| | 720 | 850 | 0.00% | 0.00% | 0.00% | 0.00% | 5.000% |
| | 680 | 719 | 0.00% | 0.00% | 0.00% | 0.00% | 5.250% |
| | 620 | 679 | 0.00% | 0.00% | 0.00% | 0.00% | 5.500% |
| Occupancy | Second | | | | | | |
| Units | 1 | 1 | | | | | |
| Term | 20 | 30 | 3 | 5 | 10 | 15 | 20 |
| | 720 | 850 | 0.00% | 0.00% | 5.125% | 5.000% | 4.875% |
| | 680 | 719 | 0.00% | 0.00% | 5.375% | 5.250% | 5.125% |
| | 620 | 679 | 0.00% | 0.00% | 5.500% | 5.375% | 5.250% |
| Occupancy | Investment | | | | | | |
| Units | 1 | 1 | | | | | |
| Term | 20 | 30 | 3 | 5 | 10 | 15 | 20 |
| | 720 | 850 | 0.00% | 0.00% | 0.00% | 5.3750% | 5.250% |
| | 680 | 719 | 0.00% | 0.00% | 0.00% | 5.6250% | 5.500% |
| | 620 | 679 | 0.00% | 0.00% | 0.00% | 5.7500% | 5.750% |
| Occupancy | Primary | | | | | | |
| Units | 1 | 1 | | | | | |
| Term | 0 | 20 | 3 | 5 | 10 | 15 | 20 |
| | 720 | 850 | 4.625% | 4.500% | 4.375% | 4.250% | 4.125% |
| | 680 | 719 | 4.875% | 4.250% | 4.125% | 4.000% | 3.875% |
| | 620 | 679 | 5.125% | 4.000% | 3.875% | 3.750% | 3.625% |
| Occupancy | Primary | | | | | | |
| Units | 2 | 2 | | | | | |
| Term | 0 | 20 | 3 | 5 | 10 | 15 | 20 |
| | 720 | 850 | 0.00% | 0.00% | 0.00% | 4.500% | 4.375% |
| | 680 | 719 | 0.00% | 0.00% | 0.00% | 4.750% | 4.625% |
| | 620 | 679 | 0.00% | 0.00% | 0.00% | 5.000% | 4.875% |
| Occupancy | Primary | | | | | | |
| Units | 3 | 4 | | | | | |
| Term | 0 | 20 | 3 | 5 | 10 | 15 | 25 |
| | 720 | 850 | 0.00% | 0.00% | 0.00% | 0.00% | 4.625% |
| | 680 | 719 | 0.00% | 0.00% | 0.00% | 0.00% | 4.875% |
| | 620 | 679 | 0.00% | 0.00% | 0.00% | 0.00% | 5.125% |
| Occupancy | Second | | | | | | |
| Units | 1 | 1 | | | | | |
| Term | 0 | 20 | 3 | 5 | 10 | 15 | 20 |
| | 720 | 850 | 0.00% | 0.00% | 4.750% | 4.625% | 4.500% |
| | 680 | 719 | 0.00% | 0.00% | 5.000% | 4.875% | 4.750% |
| | 620 | 679 | 0.00% | 0.00% | 5.250% | 5.125% | 5.000% |
| Occupancy | Investment | | | | | | |
| Units | 1 | 1 | | | | | |
| Term | 0 | 20 | 3 | 5 | 10 | 15 | 20 |
| | 720 | 850 | 0.00% | 0.00% | 0.00% | 5.000% | 4.875% |
| | 680 | 719 | 0.00% | 0.00% | 0.00% | 5.250% | 5.125% |
| | 620 | 679 | 0.00% | 0.00% | 0.00% | 5.500% | 5.375% |

FHA Rate Sheet:

| Occupancy | Primary | | | | |
|---|---|---|---|---|---|
| Units | 1 | 1 | | | |
| Term | 20 | 30 | 3.5 | 10 | 20 |
| | 720 | 850 | 4.500% | 4.375% | 4.250% |
| | 680 | 719 | 4.75% | 4.625% | 4.500% |
| | 620 | 679 | 5.00% | 4.875% | 4.750% |
| Occupancy | Primary | | | | |
| Units | 2 | 4 | | | |
| Term | 20 | 30 | 3.5 | 10 | 20 |
| | 720 | 850 | 4.875% | 4.750% | 4.625% |
| | 680 | 719 | 5.125% | 5.000% | 4.875% |
| | 620 | 679 | 5.375% | 5.250% | 5.125% |
| Occupancy | Primary | | | | |
| Units | 1 | 1 | | | |
| Term | 0 | 20 | 3.5 | 10 | 20 |
| | 720 | 850 | 4.125% | 4.000% | 3.875% |
| | 680 | 719 | 4.375% | 4.250% | 4.125% |
| | 620 | 679 | 4.625% | 4.500% | 4.375% |
| Occupancy | Primary | | | | |
| Units | 2 | 4 | | | |
| Term | 0 | 20 | 3.5 | 10 | 20 |
| | 720 | 850 | 4.500% | 4.375% | 4.250% |
| | 680 | 719 | 4.750% | 4.625% | 4.500% |
| | 620 | 679 | 5.000% | 4.875% | 4.750% |

FHA Renovation Rate Sheet

| Occupancy | Primary | | | | |
|---|---|---|---|---|---|
| Units | 1 | 1 | | | |
| Term | 20 | 30 | 3.5 | 10 | 20 |
| | 720 | 850 | 4.750% | 4.625% | 4.500% |
| | 680 | 719 | 5.00% | 4.875% | 4.750% |
| | 620 | 679 | 5.25% | 5.125% | 5.000% |
| Occupancy | Primary | | | | |
| Units | 2 | 4 | | | |
| Term | 20 | 30 | 3.5 | 10 | 20 |
| | 720 | 850 | 5.125% | 5.000% | 4.875% |
| | 680 | 719 | 5.375% | 5.250% | 5.125% |
| | 620 | 679 | 5.625% | 5.500% | 5.375% |
| Occupancy | Primary | | | | |
| Units | 1 | 1 | | | |
| Term | 0 | 20 | 3.5 | 10 | 20 |
| | 720 | 850 | 4.375% | 4.250% | 4.125% |
| | 680 | 719 | 4.625% | 4.500% | 4.375% |
| | 620 | 679 | 4.875% | 4.750% | 4.625% |
| Occupancy | Primary | | | | |
| Units | 2 | 4 | | | |
| Term | 0 | 20 | 3.5 | 10 | 20 |
| | 720 | 850 | 4.750% | 4.625% | 4.500% |
| | 680 | 719 | 5.000% | 4.875% | 4.750% |
| | 620 | 679 | 5.250% | 5.125% | 5.000% |

VA Rate Sheet:

| Occupancy | Primary | | |
|---|---|---|---|
| Units | 1 | 1 | |
| Term | 20 | 30 | 0 |
| | 720 | 850 | 4.500% |
| | 680 | 719 | 4.75% |
| | 620 | 679 | 5.00% |
| Occupancy | Primary | | |
| Units | 2 | 4 | |
| Term | 20 | 30 | 0 |
| | 720 | 850 | 4.7500% |
| | 680 | 719 | 5.00% |
| | 620 | 679 | 5.25% |
| Occupancy | Primary | | |
| Units | 1 | 1 | |
| Term | 0 | 20 | 0 |
| | 720 | 850 | 4.125% |
| | 680 | 719 | 4.375% |
| | 620 | 679 | 4.625% |
| Occupancy | Primary | | |
| Units | 2 | 4 | |
| Term | 0 | 20 | 0 |
| | 720 | 850 | 4.500% |
| | 680 | 719 | 4.750% |
| | 620 | 679 | 5.000% |

VA Renovation Rate Sheet:

| Occupancy | Primary | | |
|---|---|---|---|
| Units | 1 | 1 | |
| Term | 20 | 30 | 0 |
| | 720 | 850 | 4.750% |
| | 680 | 719 | 5.00% |
| | 620 | 679 | 5.25% |
| Occupancy | Primary | | |
| Units | 2 | 4 | |
| Term | 20 | 30 | 0 |
| | 720 | 850 | 5.125% |
| | 680 | 719 | 5.375% |
| | 620 | 679 | 5.625% |
| Occupancy | Primary | | |
| Units | 1 | 1 | |
| Term | 0 | 20 | 0 |
| | 720 | 850 | 4.375% |
| | 680 | 719 | 4.625% |
| | 620 | 679 | 4.875% |
| Occupancy | Primary | | |
| Units | 2 | 4 | |
| Term | 0 | 20 | 0 |
| | 720 | 850 | 4.750% |
| | 680 | 719 | 5.000% |
| | 620 | 679 | 5.250% |

USDA Rate Sheet:

| Occupancy | Primary | | |
|---|---|---|---|
| Units | 1 | 1 | |
| Term | 20 | 30 | 0 |
| | 720 | 850 | 4.500% |
| | 680 | 719 | 4.75% |
| | 620 | 679 | 5.00% |
| Occupancy | Primary | | |
| Units | 1 | 1 | |
| Term | 0 | 20 | 0 |
| | 720 | 850 | 4.125% |
| | 680 | 719 | 4.375% |
| | 620 | 679 | 4.625% |

Apply #units, Term, Credit and (DP/AP) %

Arrive at IR

Calculate P+I=Loan Amount

Apply P+I Formula with user's Term, Input results for IR &LA.

Calculate Total Mortgage Payment (TMP) by adding to P+I with
Taxes
Home Owners Insurance
Mortgage Insurance
Association Dues
and Flood Insurance as known

in terms of monthly rate. See formulas and supporting matrices.

Apply Annual Mortgage Insurance at a Monthly Rate from Rate Sheet for the loan program the system dictates. Input for output: #of units, % down payment, Term Example:

LOAN AMOUNT <=625,000
TERM 15.01-30 YEARS

| Annual | 0- | 5- | 10- | 15- | 20- | |
|---|---|---|---|---|---|---|
| MIP | 4.99% | 9.99% | 14.99% | 19.99% | 24.99% | 25+% |
| 1 UNIT | 0.85% | 0.80% | 0.80% | 0.80% | 0.80% | 0.80% |
| 2 UNIT | 0.85% | 0.80% | 0.80% | 0.80% | 0.80% | 0.80% |
| 3 UNIT | 0.85% | 0.80% | 0.80% | 0.80% | 0.80% | 0.80% |
| 4 UNIT | 0.85% | 0.80% | 0.80% | 0.80% | 0.80% | 0.80% |

IF LOAN PROGRAM DETERMINATION IS FNMA, THEN FNMA MMIP Rates. Input for output: #of units, % down payment, term, credit score, occupancy type. You'll see that mortgage insurance rates correspond to loan availability subject to the % down payment with respect to the occupancy type, and the #of units.

Here is an example:

| Occupancy | Primary | | | | |
|---|---|---|---|---|---|
| Units | 1 | | | | |
| | 20.1-30 Y | 95.01-97% | 95-90.01% | 90-85.01% | 85-80.01% |
| | 760+ | 0.55% | 0.41% | 0.30% | 0.19% |
| | 740-759 | 0.75% | 0.59% | 0.41% | 0.20% |
| | 720-739 | 0.95% | 0.73% | 0.50% | 0.23% |
| | 700-719 | 1.15% | 0.87% | 0.60% | 0.27% |
| | 680-699 | 1.40% | 1.08% | 0.73% | 0.32% |
| | 660-679 | 1.90% | 1.42% | 1.00% | 0.41% |
| | 640-659 | 2.05% | 1.50% | 1.05% | 0.43% |
| | 620-639 | 2.25% | 1.61% | 1.10% | 0.45% |
| Occupancy | Second | | | | |
| Units | 1 | | | | |
| | 20.1-30 Y | 95.01-97% | 95-90.01% | 90-85.01% | 85-80.01% |
| | 760+ | | | 0.42% | 0.31% |
| | 740-759 | | | 0.54% | 0.33% |
| | 720-739 | | | 0.64% | 0.37% |
| | 700-719 | | | 0.77% | 0.44% |
| | 680-699 | | | 0.93% | 0.52% |
| | 660-679 | | | 1.35% | 0.76% |
| | 640-659 | | | 1.45% | 0.83% |
| | 620-639 | | | 1.55% | 0.90% |
| Occupancy | Investment | | | | |
| Units | 1 | | | | |
| | 20.1-30 Y | 95.01-97% | 95-90.01% | 90-85.01% | 85-80.01% |
| | 760+ | | | | 0.53% |
| | 740-759 | | | | 0.58% |
| | 720-739 | | | | 0.61% |
| | 700-719 | | | | 0.74% |
| | 680-699 | | | | 0.82% |
| | 660-679 | | | | 0.98% |
| | 640-659 | | | | 1.08% |
| | 620-639 | | | | 1.20% |
| Occupancy | Primary | | | | |
| Units | 2 | | | | |
| | 20.1-30 Y | 95.01-97% | 95-90.01% | 90-85.01% | 85-80.01% |
| | 760+ | | | | 0.19% |
| | 740-759 | | | | 0.20% |
| | 720-739 | | | | 0.23% |
| | 700-719 | | | | 0.27% |
| | 680-699 | | | | 0.32% |
| | 660-679 | | | | 0.41% |
| | 640-659 | | | | 0.43% |
| | 620-639 | | | | 0.45% |
| Occupancy | Primary | | | | |
| Units | 3-4 | FNMA Financing UNAVAILABLE | | | |
| Occupancy | Second | | | | |
| Units | 2-4 | FNMA Financing UNAVAILABLE | | | |
| Occupancy | Investment | | | | |
| Units | 2-4 | FNMA Financing UNAVAILABLE | | | |
| Occupancy | Primary | | | | |
| Units | 1 | | | | |
| | 0-20 Y | 95.01-97% | 95-90.01% | 90-85.01% | 85-80.01% |
| | 760+ | 0.37% | 0.28% | 0.19% | 0.17% |
| | 740-759 | 0.50% | 0.38% | 0.21% | 0.18% |
| | 720-739 | 0.65% | 0.45% | 0.25% | 0.19% |
| | 700-719 | 0.77% | 0.54% | 0.28% | 0.20% |
| | 680-699 | 0.97% | 0.65% | 0.33% | 0.20% |
| | 660-679 | 1.30% | 0.80% | 0.42% | 0.22% |
| | 640-659 | 1.45% | 0.93% | 0.47% | 0.24% |
| | 620-639 | 1.65% | 1.09% | 0.55% | 0.27% |
| Occupancy | Second | | | | |
| Units | 1 | | | | |
| | 0-20 Y | 95.01-97% | 95-90.01% | 90-85.01% | 85-80.01% |
| | 760+ | | | 0.31% | 0.29% |
| | 740-759 | | | 0.33% | 0.30% |
| | 720-739 | | | 0.37% | 0.31% |
| | 700-719 | | | 0.40% | 0.32% |
| | 680-699 | | | 0.45% | 0.32% |
| | 660-679 | | | 0.54% | 0.34% |
| | 640-659 | | | 0.59% | 0.36% |
| | 620-639 | | | 0.67% | 0.39% |
| Occupancy | Investment | | | | |
| Units | 1 | | | | |
| | 0-20 Y | 95.01-97% | 95-90.01% | 90-85.01% | 85-80.01% |
| | 760+ | | | | 0.51% |
| | 740-759 | | | | 0.52% |
| | 720-739 | | | | 0.53% |
| | 700-719 | | | | 0.54% |
| | 680-699 | | | | 0.54% |
| | 660-679 | | | | 0.56% |
| | 640-659 | | | | 0.58% |
| | 620-639 | | | | 0.61% |
| Occupancy | Primary | | | | |
| Units | 2 | | | | |
| | 0-20 Y | 95.01-97% | 95-90.01% | 90-85.01% | 85-80.01% |
| | 760+ | | | | 0.17% |
| | 740-759 | | | | 0.18% |
| | 720-739 | | | | 0.19% |
| | 700-719 | | | | 0.20% |
| | 680-699 | | | | 0.20% |
| | 660-679 | | | | 0.22% |
| | 640-659 | | | | 0.24% |
| | 620-639 | | | | 0.27% |
| Occupancy | Primary | | | | |
| Units | 3-4 | FNMA Financing UNAVAILABLE | | | |
| Occupancy | Second Home | | | | |
| Units | 2-4 | FNMA Financing UNAVAILABLE | | | |
| Occupancy | Investment | | | | |

| | | |
|---|---|---|
| Units | 2-4 | FNMA Financing UNAVAILABLE |

Anticipating Association Fees Monthly Based on Information Provided in MIS Apply these Rates to Normalize Information to Monthly Rate:

| Frequency | Rate Multiplier |
|---|---|
| Monthly | 1 |
| Quarterly | 0.333333333 |
| Biannually | 0.166666667 |
| Annually | 0.083333333 |

For Home Owners Insurance (HOI) Monthly Calculation:

Look up annual base rate (ABR) by state add to that [(AP−200,000)/(1200)]12

As required in dynamic calculations, Estimate HOI with renovation: replace AP with [AP+(Renovation Amount multiply 1.2)] and fulfill the balance of calculations for HOI Monthly Calc. If Total Mortgage Payment (TMP) from order of operations above is less than Qualified Mortgage Payment (QMP) check if a Financed Renovation Budget (FRB) is available.

https://www.insurance.com/home-and-renters-insurance/home-
insurance-basics/average-homeowners-insurance-rates-by-state

| State | | Average annual base rate |
|---|---|---|
| Alabama | Alabama - AL | $2,314 |
| Alaska | Alaska - AK | $908 |
| Arizona | Arizona - AZ | $813 |
| Arkansas | Arkansas - AR | $2,063 |
| California | California - CA | $793 |
| Colorado | Colorado - CO | $1,417 |
| Connecticut | Connecticut - CT | $902 |
| DC | District of Columbia - DC | $706 |
| Delaware | Delaware - DE | $748 |
| Florida | Florida - FL | $3,575 |
| Georgia | Georgia - GA | $1,103 |
| Hawaii | Hawaii - HI | $337 |
| Idaho | Idaho - ID | $622 |
| Illinois | Illinois - IL | $1,053 |
| Indiana | Indiana - IN | $1,198 |
| Iowa | Iowa - IA | $1,205 |
| Kansas | Kansas - KS | $1,939 |
| Kentucky | Kentucky - KY | $1,355 |
| Louisiana | Louisiana - LA | $2,979 |
| Maine | Maine - ME | $721 |
| Maryland | Maryland - MD | $866 |
| Massachusetts | Massachusetts - MA | $1,190 |
| Michigan | Michigan - MI | $1,073 |
| Minnesota | Minnesota - MN | $1,333 |
| Mississippi | Mississippi - MS | $2,290 |
| Missouri | Missouri - MO | $1,722 |
| Montana | Montana - MT | $1,175 |
| Nebraska | Nebraska - NE | $1,583 |
| Nevada | Nevada - NV | $703 |
| New Hampshire | New Hampshire - NH | $680 |
| New Jersey | New Jersey - NJ | $711 |
| New Mexico | New Mexico - NM | $1,197 |
| New York | New York - NY | $935 |
| North Carolina | North Carolina - NC | $773 |
| North Dakota | North Dakota - ND | $1,354 |
| Ohio | Ohio - OH | $864 |
| Oklahoma | Oklahoma - OK | $2,651 |
| Oregon | Oregon - OR | $643 |
| Pennsylvania | Pennsylvania - PA | $801 |
| Rhode Island | Rhode Island - RI | $1,205 |
| South Carolina | South Carolina - SC | $1,402 |
| South Dakota | South Dakota - SD | $1,379 |
| Tennessee | Tennessee - TN | $1,521 |
| Texas | Texas - TX | $1,945 |
| Utah | Utah - UT | $642 |
| Vermont | Vermont - VT | $589 |
| Virginia | Virginia - VA | $959 |
| Washington | Washington - WA | $653 |
| West Virginia | West Virginia - WV | $1,288 |
| Wisconsin | Wisconsin - WI | $788 |
| Wyoming | Wyoming - WY | $976 |

First does the LP offer a FRB.

If not, could another loan program offer FRB for Occupancy, Units, % DP.

USDA becomes FHA or FNMA.

FNMA becomes FHA.

Here is the logic rules:

IF OWNER OCCUPANT, FANNIE MAE 1 (DP/PP =>5%), 2
(DP/PP =>15%), 3-4 (DP/PP =>25%)
IF SECOND HOME, FANNIE MAE, 1 (DP/PP >=5%)
IF INVESTMENT, FANNIE MAE, 1 (DP/PP >=15%)
IF Owner Occupant, VA, 1-4 (DP >=0%)
DOES NOT APPLY TO USDA

Calculate Financed Renovation Budget (FRB) not to exceed QMP.

MP at AP with Renovation Interest Rate (RIR)

Start with QMP

Then Subtract Total Payment for Subject Property at IR for renovation with Taxes, Mortgage Insurance, Homeowners, Association Fees for subject property at asking price.

Use this difference of monthly payment as accounting for the renovation amount multiplied by the up front mortgage insurance funding fee as applicable multiplied by [(i×((1+i)\hat{ }n))/((1+i)\hat{ }n−1)

Where “i” is the renovation interest rate in decimal, n is period term (years) multiplied by 12 months

Apply Algebra and Solve for Renovation Amount Estimate that can be financed and not exceed QMP.

Since DP % is applied to determine loan program it is assumed here that buyer may negotiate a seller assist to offset closing costs and thereby increasing funds from liquid reserves that are available for financing and accommodate for required DP % for the loan program selected. So DP % remains constant, it is reasonable to conceive a dynamic logic to DP % with increased BLA now including the Renovation Budget. Alternative approach to determining results, one skilled (Real Estate Agent or Mortgage Loan Originator) may want to bypass LR and indicate a DP as a %.

Here is one iteration possibility and logic follows above the same once Loan Program is Defined here:

OPTIONS AVAILABLE BY DROP DOWN, BASED ON USER SELECTION LEFT TO RIGHT
USER SELECTS: Single Family 1 UNIT, MULTIFAMILY: 2-4 Family

| USER SELECTS | | | | |
|---|---|---|---|---|
| OCCUPANCY: | | | DOWNPAYMENT | BACKEND APPLIES |
| PRIMARY | VeteranYN | YES, | 1-4 UNITS: Veteran, | VA |
| | | Regular | FIRSTUSE 0% | REGULARMILITARYFIRSTUSE |
| | | | 1-4 UNITS: Veteran, | VA |
| | | | REPEAT 0% | REGULARMILITARYREPEAT |
| | USEVA | YES, | 1-4 UNITS: Veteran, | VA RESERVESFIRSTUSE |
| | BENEFITS? | RESERVE | FIRSTUSE 0% | |
| | | | 1-4 UNITS: Veteran, | VA RESERVESREPEAT |
| | | | REPEAT 0% | |
| | | NO | 1-4 UNITS: 3.5% | See below 1 line. |

FHA, IF 1 UNIT & USDA ELIGIBLE, THEN SHOW 0% DP USDA IF PAYMENT LESS THAN
MAX PAYMENT, BUT ALSO SHOW FHA PAYMENT WITH 3.5%, CALCULATE RENO
BUDGET OFF FHA PAYMENT, SINCE USDA DOESN'T HAVE RENO

| | 1 UNIT: 10% | FNMA |
|---|---|---|
| | 1 UNIT: 20% | FNMA |
| | 2 UNIT: 15% | FNMA |
| | 3-4 UNIT: 25% | FNMA |
| SECOND HOME | 1 UNIT: 10% | FNMA |
| INVESTMENT | 1 UNIT: 15% | FNMA |

| | |
|---|---|
| 2-4 UNITS: 25% | FNMA |

Results of properties displayed with property information consistent with the state of the art modified to disclose total monthly payment in the results and monies available to finance for renovation up to max qualifying monthly payment.

It is conceived that a mortgage loan originator will enter a qualifying monthly payment to provide the agent or borrower the function of then conducting a property detail search and therefore in its totality limiting results to si borrower mortgage qualified homes.

It is conceived that the tool will be used by areal estate agent in cooperation with a mortgage loan originator to display to their client the borrower/buyer qualified homes up to the clients approved max monthly payment. It is expected that this will save the public time and hassle. And provide agents additional bandwidth to serve more clients or bring save time in attention to other important aspects of the home purchase lifecycle.

It is conceived that the renovation budget will provide the audience a context for what is possible in improvements to a home within a budget.

It is conceived that it will provide the public access to reliable licensed and insured qualified contractors to consult on defining a scope of work and incorporating that into the purchase negotiation process and expected after improved condition of the home the client will purchase.

Various modifications can be made in the details of the various embodiments of the methods of the present invention, all within the scope and spirit of the invention and defined by the appended claims.

1. A method for locating real estate for purchase, the method comprising:
a) providing a maximum possible monthly real estate expenditure for a user;
b) providing a database of real estate listings including location and asking price,
c) providing mortgage information including mortgage provider, mortgage interest rate, mortgage term, mortgage type, and any associated fees,
d) defining a desired geographic location;
e) identifying real estate being offered for sale within the desired geographical location,
f) computing the monthly mortgage cost for each real estate property being offered within the desired geographical area;
g) comparing the monthly mortgage cost for each real estate offering within the desired geographical area with the maximum possible monthly real estate expenditure for the user; and
h) displaying to the user each real estate offering within the desired geographical area which has a monthly mortgage cost less than or equal to the user's maximum possible monthly real estate expenditure.

2. A method according to claim 1 further including:
a) computing, for each mortgage provider, the cost for each real estate offering within the desired geographical area;
b) comparing the monthly mortgage cost for each mortgage provider for each real estate offering within the desired geographical area with the maximum possible monthly real estate expenditure for the user; and
c) displaying to the user each real estate offering within the desired geographical area which has a monthly mortgage cost less than or equal to the user's maximum possible monthly real estate expenditure for each mortgage provider.

3. A method according to claim 1 further including:
a) providing real estate tax information for real properties, the real estate tax information including real property location and associated real estate tax;
b) computing the real estate tax for each real estate property being offered for sale within the desired geographical location;
c) computing a monthly allocation of the real estate tax for each real estate property being offered within the desired geographical area;
d) computing the monthly cost of ownership for each real estate property being offered within the desired geographical location, the monthly cost of ownership including the monthly allocation of the real estate tax and the monthly mortgage cost; and
e) displaying to the user each real estate offering within the desired geographical area which has a monthly cost of ownership less than or equal to the user's maximum possible monthly real estate expenditure.

4. A method according to claim 3 further including:
a) providing utility cost information for real properties, the real estate tax information including real property location and associated utility cost;
b) computing the utility cost for each real estate property being offered for sale within the desired geographical location;
c) computing a monthly utility cost for each real estate property being offered within the desired geographical area;
d) computing a monthly total cost of ownership for each real estate property being offered within the desired geographical location, the monthly cost of ownership including the monthly allocation of the real estate tax, the monthly mortgage cost; and the monthly utility cost;
e) displaying to the user each real estate offering within the desired geographical area which has a monthly total cost of ownership less than or equal to the user's maximum possible monthly real estate expenditure.

5. A method for locating real estate for purchase, the method comprising:
a) providing a maximum possible monthly real estate expenditure for a user;
b) providing a database of real estate listings including location and asking price,
c) providing mortgage information including mortgage provider, mortgage interest rate, mortgage term, mortgage type, and any associated fees,
d) providing real estate tax information for real properties, the real estate tax information including real property location and associated real estate tax;
e) defining a desired geographic location;
f) identifying real estate being offered for sale within the desired geographical location,
g) computing the monthly mortgage cost for each real estate property being offered within the desired geographical area;
h) computing the real estate tax for each real estate property being offered for sale within the desired geographical location;
i) computing a monthly allocation of the real estate tax for each real estate property being offered within the desired geographical area;
j) computing a monthly cost of ownership for each real estate property being offered within the desired geographical location, the monthly cost of ownership including the monthly allocation of the real estate tax and the monthly mortgage cost; and
k) comparing the monthly cost of ownership for each real estate offering within the desired geographical area with the maximum possible monthly real estate expenditure for the user; and
l) displaying to the user each real estate offering within the desired geographical area which has a monthly cost of ownership less than or equal to the user's maximum possible monthly real estate expenditure.

6. A method according to claim 5 further including:
a) computing, for each mortgage provider, the cost for each real estate offering within the desired geographical area;
b) comparing the monthly mortgage cost for each mortgage provider for each real estate offering within the desired geographical area with the maximum possible monthly real estate expenditure for the user; and
c) displaying to the user each real estate offering within the desired geographical area which has a monthly mortgage cost less than or equal to the user's maximum possible monthly real estate expenditure for each mortgage provider.

7. A method according to claim 6 further including:
a) providing utility cost information for real properties, the real estate tax information including real property location and associated utility cost;
b) computing the utility cost for each real estate property being offered for sale within the desired geographical location;
c) computing a monthly utility cost for each real estate property being offered within the desired geographical area;
d) computing a monthly total cost of ownership for each real estate property being offered within the desired geographical location, the monthly cost of ownership including the monthly allocation of the real estate tax, the monthly mortgage cost; and
the monthly utility cost;
e) displaying to the user each real estate offering within the desired geographical area which has a monthly total cost of ownership less than or equal to the user's maximum possible monthly real estate expenditure.

8. The method of claim 1 further comprising:
a) identifying comparable real estate properties to each real estate offering within the desired geographical area which has a monthly mortgage cost less than or equal to the user's maximum possible monthly real estate expenditure;
b) computing a prediction of the expected days remaining on market for at least one of the each real estate offering; and
c) presenting to the user the prediction.

9. The method of claim 8 wherein the comparable real estate properties are determined by weighing at least one factor selected from the group consisting of location, price per square foot, condition, and home design.

10. The method of claim 1 further comprising:
a) computing the amount of renovation financing available for at least one of each real estate offering within the desired geographical area which has a monthly mortgage cost less than or equal to the user's maximum possible monthly real estate expenditure; and
b) displaying the computed amount of renovation financing available to the user.
